(19) United States
(12) Patent Application Publication
(10) Pub. No.: US 2025/0070130 A1
(43) Pub. Date: Feb. 27, 2025

(54) NEGATIVE ELECTRODE ACTIVE MATERIAL AND RECHARGEABLE LITHIUM BATTERY INCLUDING SAME

(71) Applicant: SAMSUNG SDI CO., LTD., YONGIN-SI (KR)

(72) Inventors: HYEJIN KIM, YONGIN-SI (KR); ILYOUNG CHOI, YONGIN-SI (KR); DEOK-HYUN KIM, YONGIN-SI (KR); YOUNGUGK KIM, YONGIN-SI (KR); JAEHOU NAH, YONGIN-SI (KR); SUNIL PARK, YONGIN-SI (KR); EUNJI KANG, YONGIN-SI (KR); JAEWON KIM, YONGIN-SI (KR); DOORI OH, YONGIN-SI (KR); NARAE KIM, YONGIN-SI (KR); YOOKYUNG KIM, YONGIN-SI (KR); BANSEOK LEE, YONGIN-SI (KR)

(21) Appl. No.: 18/638,791

(22) Filed: Apr. 18, 2024

(30) Foreign Application Priority Data
Aug. 23, 2023 (KR) 10-2023-0110774

(51) Int. Cl. H01M 4/36; H01M 4/02; H01M 4/04; H01M 4/133; H01M 4/137; H01M 4/1393; H01M 4/1399; H01M 4/587; H01M 4/60; H01M 10/052

(52) U.S. Cl. CPC H01M 4/366; H01M 4/0471; H01M 4/133; H01M 4/137; H01M 4/1393; H01M 4/1399; H01M 4/587; H01M 4/604; H01M 10/052; H01M 2004/021; H01M 2004/027

(57) ABSTRACT

A negative electrode active material, including a core which includes a silicon-carbon composite; and a polymer coating layer on the core including a silicon-carbon composite, wherein the negative electrode active material has a (100) plane peak and a (002) plane peak during an X-ray diffraction measurement using a CuKα ray.

### CROSS-REFERENCE TO RELATED APPLICATION

This application claims priority to and the benefit of Korean Patent Application No. 10-2023-0110774 filed in the Korean Intellectual Property Office on Aug. 23, 2023, the entire contents of which are incorporated herein by reference.

### BACKGROUND

### 1. Field

Embodiments relate to a negative electrode active materials and rechargeable lithium batteries including the same.

### 2. Description of the Related Art

Recently, with a rapid spread of electronic devices such as mobile phones, laptop computers, electric vehicles, and the like, a demand for small, lightweight, and relatively high-capacity rechargeable lithium batteries has rapidly increased. Accordingly, research and development for improving the performance of rechargeable lithium batteries is actively progressing.

### SUMMARY

Embodiments are directed to a negative electrode active material, including a core including a silicon-carbon composite; and a polymer coating layer on the core, wherein the negative electrode active material has a (100) plane peak and a (002) plane peak during X-ray diffraction measurement using a CuKα ray.

The negative electrode active material may have a first peak appearing at a wavelength of about 1,550 cm⁻¹ to about 1,650 cm⁻¹ and a second peak appearing at a wavelength of about 2,200 cm⁻¹ to about 2,300 cm⁻¹ in an FT-IR analysis graph.

The (100) plane peak may appear within a range of 2θ=15° to 20° and the (002) plane peak appears within a range of 2θ=22° to 28°.

An intensity ratio of the (002) plane peak to (100) plane peak may be in a range of about 0.2 to about 3.

A ratio of a height of the second peak to a height of the first peak may be about 0.2 to about 30.

The polymer coating layer may include linear polyacrylonitrile and cyclic polyacrylonitrile.

A mixing ratio of the linear polyacrylonitrile and the cyclic polyacrylonitrile may be about 20:80 to about 80:20 by weight.

The mixing ratio of the linear polyacrylonitrile and the cyclic polyacrylonitrile may be about 40:60 to about 60:40 by weight.

An amount of the polymer coating layer may be about 0.1 wt % to about 5 wt % based on a total weight of the negative electrode active material.

An amount of the polymer coating layer may be about 0.5 wt % to about 3 wt % based on a total weight of the negative electrode active material.

A thickness of the polymer coating layer may be about 1 nm to about 30 nm.

The silicon-carbon composite may include silicon nanoparticles and an amorphous carbon coating layer on a surface of the silicon nanoparticles.

The silicon nanoparticles may have a diameter of about 10 nm to about 1,000 nm.

The silicon-carbon composite may further include crystalline carbon.

Embodiments are directed to a method of preparing a negative active electrode, including preparing a mixture by mixing polyacrylonitrile liquid and silicon-carbon composite; drying the mixture to produce a dried product; and performing a heat treatment on the dried product.

The polyacrylonitrile liquid may include linear polyacrylonitrile and an organic solvent.

A mixing ratio of the polyacrylonitrile and the silicon-carbon composite may be about 0.01:99.9 to about 5:95 by weight.

The drying may be performed at about 60° C. to about 120° C.

The heat treatment may be performed at about 200° C. to about 400° C.

Embodiments provide a rechargeable lithium battery, including a negative electrode including the negative electrode active material; a positive electrode; and an electrolyte.

### BRIEF DESCRIPTION OF THE DRAWINGS

Features will become apparent to those of skill in the art by describing in detail exemplary embodiments with reference to the attached drawings in which:

FIGS. 1 and 2 are cross-sectional schematic views showing rechargeable lithium batteries according to some embodiments;

FIGS. 3 and 4 are perspective schematic views showing rechargeable lithium batteries according to some embodiments;

FIG. 5 is a graph showing XRD results for the negative electrode active materials of Examples 1 to 5 and Comparative Examples 1 to 3; and

FIG. 6 is a graph showing FT-IR results for the negative electrode active materials of Examples 1 to 5 and Comparative Examples 1 to 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, it will be understood that when an element such as a layer, film, region, or substrate is referred to as being “on” another element, it may be directly on the other element or intervening elements may also be present.

Unless otherwise specified in this specification, what is indicated in the singular may also include the plural. Unless otherwise specified, “A or B” may mean “including A, including B, or including A and B”.

As used herein, “combination thereof” means a mixture, laminate, composite, copolymer, alloy, blend, reaction product, and the like of the constituents.

As used herein, when a definition is not otherwise provided, a particle diameter may be an average particle diameter. The particle diameter means the average particle diameter (D50), which means the diameter of particles having a cumulative volume of 50 volume % in the particle size distribution. The average particle size (D50) may be measured by a suitable method, for example, by a particle size analyzer, a transmission electron microscopic image, or a scanning electron microscopic image. Alternatively, a dynamic light-scattering measurement device may be used to perform a data analysis, and the number of particles is counted for each particle size range. From this, the average particle diameter (D50) value may be easily obtained through a calculation. Alternatively, it may be measured using a laser diffraction method. When measuring by the laser diffraction method, more specifically, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

A negative electrode active material according to some embodiments may include a core including a silicon-carbon composite and a polymer coating layer on the core.

In some embodiments, the negative electrode active material may have a (100) plane peak and a (002) plane peak, when measured by X-ray diffraction using a CuKα ray. The (100) plane peak may be a peak that appears, e.g., at 2θ=15° to 20° in an X-ray diffraction graph, and the (002) plane peak may be a peak that appears, e.g., at 2θ=22° to 28° in an X-ray diffraction graph.

An intensity ratio of the (002) plane peak to the (100) plane peak, i.e., I(002)/I(100), may be, e.g., about 0.2 to about 3, about 0.4 to about 2.5, or about 0.5 to about 2.2. If the I(002)/I(100) value is within the above ranges, electrical conductivity and cycle-life characteristics may be further improved.

In some embodiments, peak intensity may be a height value of the peak, or may be an integrated area value of the peak. In some embodiments, peak intensity may refer to a height of the peak.

The negative electrode active material according to some embodiments may have a first peak appearing at a wavelength of about 1,550 cm⁻¹ to about 1,650 cm⁻¹ and a second peak appearing at a wavelength of about 2,200 cm⁻¹ to about 2,300 cm⁻¹ when measured by FT-IR. The first peak may be a peak derived from —C═N— or —C═C—, and the second peak may be a peak derived from —C≡N. For example, the first peak may indicate the presence of —C═N— or —C═C— and the second peak may indicate the presence of —C≡N.

A ratio of the second peak height to the first peak height may be about 0.2 to about 30, about 1 to about 25, or about 2 to about 10. If the ratio of the second peak height to the first peak height is within the above ranges, electrical conductivity and cycle-life characteristics may be further improved.

In an implementation, the negative electrode active material may include the polymer coating layer, and direct contact between the active material and the electrolyte may be prevented. Therefore, the SEI (solid electrolyte interface) formed on the surface of the active material through the reaction between the active material and the electrolyte may be formed at an appropriate amount, and the cycle-life improvement effect due to SEI formation may be appropriately obtained. If the SEI is formed in excessive amounts, the SEI may reduce the electrical contact between the active material and the current collector, consume the electrolyte inside the battery, and reduce mobility characteristics of lithium ions, thereby reducing electrochemical activity. However, in some embodiments, the advantages alone resulting from SEI generation may be appropriately utilized without such problems occurring.

In some embodiments, the polymer coating layer may include linear polyacrylonitrile and cyclic polyacrylonitrile. The linear polyacrylonitrile may be an elastic polymer. Therefore, the linear polyacrylonitrile may serve as a buffer to absorb the volume expansion that occurs if charging and discharging a negative electrode active material including silicon. In some implementations, the cyclic polyacrylonitrile may be a polymer with electrical conductivity. Therefore, if a negative electrode active material including silicon is repeatedly charged and discharged, cracks may occur due to volume expansion and contraction, and cyclic polyacrylonitrile may improve the decrease in conductivity caused by the cracks, thereby improving the cycle-life characteristics. For example, the cyclic polyacrylonitrile with electrical conductivity may help limit the decrease in conductivity caused by cracks in the negative electrode active material.

Therefore, the negative electrode active material according to some embodiments may include both linear polyacrylonitrile and cyclic polyacrylonitrile, and thus may exhibit excellent electrochemical properties.

The effect of including both linear polyacrylonitrile and cyclic polyacrylonitrile may be obtained if these polymers are formed as a coating layer on the surface of a silicon-carbon composite. If the silicon-carbon composite and these polymers are simply physically mixed, the surface of the silicon-carbon composite may not be protected and side reactions with an electrolyte that occur on the surface may not be effectively prevented, so that the effect of improving cycle-life may not be obtained.

In some embodiments, the linear polyacrylonitrile may be represented by Chemical Formula 1, and cyclic polyacrylonitrile may be represented by Chemical Formula 2.

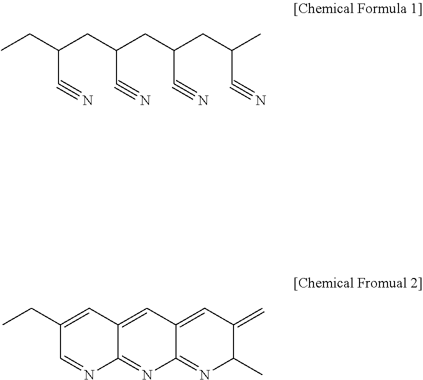 [SMILES: CCC(C#N)CC(C#N)CC(C#N)CC(C)C#N ; C=C1C=c2cc3cc(CC)cnc3nc2=NC1C]

A mixing ratio of the linear polyacrylonitrile and the cyclic polyacrylonitrile may be, e.g., about 20:80 to about 80:20, about 40:60 to about 60:40, or about 45:55 to about 55:45. In the coating layer according to some embodiments, if the mixing ratio of the linear polyacrylonitrile and cyclic polyacrylonitrile satisfies the above ranges, both the volume expansion reduction effect due to the excellent adhesive properties of the linear polyacrylonitrile and the excellent electrical conductivity of the cyclic polyacrylonitrile may be obtained.

In some implementations, an amount of the polymer coating layer may be, e.g., about 0.1 wt % to about 5 wt %, about 0.5 wt % to about 3 wt %, or about 0.7 wt % to about 3 wt % based on a total weight of the negative electrode active material. If the amount of the coating layer is within the above ranges, the advantages of forming a polymer coating layer may be obtained more effectively while maintaining appropriate capacity and without increasing resistance.

In the negative electrode active material of some embodiments, the polymer coating layer may be present on the surface of the core, and a thickness of the polymer coating layer may be about, e.g., 1 nm to about 30 nm, about 2 nm to about 20 nm, or about 3 nm to about 10 nm. If the thickness of the polymer coating layer is within the above ranges, the advantages of forming the polymer coating layer may be effectively obtained, side reactions with the electrolyte may be more effectively suppressed, and electron transfer from the current collector to the negative electrode active material may properly occur.

In the negative electrode active material according to some embodiments, the core silicon-carbon composite may include silicon nanoparticles and an amorphous carbon coating layer on the surface of the silicon nanoparticles. The silicon-carbon composite may include an agglomerated product, where at least one silicon nanoparticle is agglomerated, and an amorphous carbon coating layer on the surface of the agglomerated product.

A particle diameter of the silicon nanoparticles may be, e.g., about 10 nm to about 1,000 nm, and according to some implementations, it may be, e.g., about 10 nm to about 200 nm, or about 20 nm to about 150 nm. If the particle size of the silicon nanoparticles is within the above ranges, excessive volume expansion that occurs during charging and discharging may be suppressed, and disconnection of the conductive path due to particle crushing during charging and discharging may be prevented.

In the amorphous carbon coating layer, the amorphous carbon may be soft carbon, hard carbon, a mesophase pitch carbonized product, sintered coke, or a combination thereof. A thickness of the amorphous carbon coating layer may be, e.g., about 1 nm to about 2 m, about 1 nm to about 500 nm, about 10 nm to about 300 nm, or about 20 nm to about 200 nm. If the thickness of the amorphous carbon coating layer is within the above ranges, silicon volume expansion may be well suppressed during charging and discharging.

The silicon-carbon composite may further include crystalline carbon. If the silicon-carbon composite further includes crystalline carbon, it may include an assembly of silicon nanoparticles and crystalline carbon, and an amorphous carbon coating layer on the surface of the assembly.

The crystalline carbon may be, e.g., unspecific-shaped, plate-shaped, flake-shaped, spherical or fibrous, such as natural graphite, artificial graphite, or a combination thereof.

If the silicon-carbon composite includes silicon nanoparticles and an amorphous carbon coating layer, an amount of the silicon nanoparticles may be, e.g., about 30 wt % to about 70 wt %, or about 40 wt % to about 65 wt %, based on a total 100 wt % of the silicon-carbon composite. An amount of the amorphous carbon coating layer may be, e.g., about 30 wt % to about 70 wt %, or about 35 wt % to about 60 wt %, based on 100% by weight of the total silicon-carbon composite.

If the silicon-carbon composite further includes crystalline carbon, the amount of the silicon nanoparticles may be, e.g., about 20 wt % to about 70 wt %, or about 25 wt % to about 65 wt %, based on a total 100 wt % of the silicon-carbon composite. Based on a total 100 wt % of the silicon-carbon composite, the amount of amorphous carbon may be, e.g., about 25 wt % to about 70 wt %, or about 25 wt % to about 60 wt %, and the amount of crystalline carbon may be about 1 wt % to about 20 wt %, or about 5 wt % to about 15 wt %.

### <Method of Preparing Negative Electrode Active Material>

The negative electrode active material according to some embodiments may be prepared through the following process. The silicon-carbon composite may be added to a polyacrylonitrile liquid and then mixed.

The polyacrylonitrile liquid may be prepared by adding linear polyacrylonitrile to an organic solvent. The organic solvent may be, e.g., dimethylformamide, dimethylacetamide, dimethyl sulfoxide, ethylene carbonate, propylene carbonate, or a combination thereof.

A concentration of the polyacrylonitrile liquid may be adjusted to reach the amount of the polymer coating layer included in the final negative electrode active material. In an implementation, in the mixing process, a mixing ratio of the polyacrylonitrile and the silicon-carbon composite may be, e.g., about 0.1:99.9 to about 5:95 by weight ratio, about 0.5:99.5 to about 3:97 by weight ratio, or about 0.7:99.3 to about 3:97 by weight ratio.

The resulting mixture may be dried to remove the organic solvent. This drying process may be performed at a temperature sufficient to remove the organic solvent, e.g., at about 60° C. to about 120° C. or about 70° C. to about 100° C. This process may prepare a product in which silicon-carbon composite surface is coated with polyacrylonitrile.

Subsequently, the dried product may be heat treated to prepare a negative electrode active material. The heat treatment process may be performed at, e.g., about 200° C. to about 400° C., or about 250° C. to about 300° C. According to the heat treatment process, the linear polyacrylonitrile may be partially converted to cyclic polyacrylonitrile. Accordingly, a polymer coating layer including linear polyacrylonitrile and cyclic polyacrylonitrile may be formed on the surface of the negative electrode active material.

If the heat treatment process is performed in the above temperature ranges, a portion of the linear polyacrylonitrile may be appropriately converted into cyclic polyacrylonitrile. If the heat treatment process is performed below about 200° C., conversion to cyclic polyacrylonitrile may not occur sufficiently, and if performed above 400° C., all linear polyacrylonitrile may be converted to cyclic polyacrylonitrile.

The heat treatment process may be performed under an air atmosphere, a vacuum atmosphere, a nitrogen atmosphere, or an argon atmosphere.

### <Rechargeable Lithium Battery>

Some embodiments provide a rechargeable lithium battery including a negative electrode, a positive electrode, and an electrolyte. The negative electrode may include a current collector and a negative electrode active material layer on the current collector and including the negative electrode active material according to some embodiments.

The negative electrode active material according to some embodiments may be included as the first negative electrode active material, and crystalline carbon may be included as the second negative electrode active material. A mixing ratio of the first negative electrode active material and the second negative electrode active material may be a weight ratio of, e.g., about 20:80 to about 10:90. In some embodiments, the negative electrode active material may include the first negative electrode active material and the second negative electrode active material in a weight ratio of, e.g., about 18:82 to about 12:88.

In the negative electrode active material layer, an amount of the negative electrode active material may be, e.g., about 95 wt % to about 98 wt % based on a total 100 wt % of the negative electrode active material layer.

The negative electrode active material layer may include a binder and may further include a conductive material. An amount of the binder may be, e.g., about 1 wt % to about 5 wt % based on a total 100 wt % of the negative electrode active material layer. An amount of the conductive material may be, e.g., about 1 wt % to about 5 wt % based on a total 100 wt % of the negative electrode active material layer.

The binder may serve to well attach the negative electrode active material particles to each other and also to well attach the negative electrode active material to the current collector. The binder may be, e.g., a non-aqueous binder, an aqueous binder, or a combination thereof.

The non-aqueous binder may include, e.g., polyvinylchloride, carboxylated polyvinylchloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, a (meth)acrylated styrene-butadiene rubber, a (meth)acrylonitrile-butadiene rubber, a (meth)acryl rubber, a butyl rubber, a fluoro rubber, polyethylene oxide, polyvinyl pyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

The negative electrode binder may be a cellulose-based compound, and this cellulose-based compound may be used together with the aqueous binder. The cellulose-based compound may be one or more of carboxymethyl cellulose, hydroxypropylmethyl cellulose, methyl cellulose, or an alkali metal salt thereof. The alkali metal may be, e.g., Na, K, or Li. The cellulose-based compound may serve as a binder or as a thickener that may provide viscosity. In some embodiments, the cellulose-based compound may be used in an appropriate amount within the binder amount, but, e.g., it may about 0.1 parts by weight to about 3 parts by weight based on 100 parts by weight of the negative electrode active material.

The dry binder may be a polymer material capable of being fibrous, and may be, e.g., polytetrafluoroethylene, polyvinylidene fluoride, a polyvinylidene fluoride-hexafluoropropylene copolymer, polyethylene oxide, or a combination thereof.

The conductive material may be used to impart conductivity to the electrode, and any material that does not cause chemical change and conducts electrons may be used in the battery. Examples thereof may include, e.g., a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal.

### [Positive Electrode]

The positive electrode may include a current collector and a positive electrode active material layer on the current collector. The positive electrode active material layer may include a positive electrode active material and may further include a binder and/or a conductive material. In an implementation, the positive electrode may further include an additive that may serve as a sacrificial positive electrode.

The positive electrode active material may include lithiated intercalation compounds that reversibly intercalate and deintercalate lithium ions. In an implementation, at least one of a composite oxide of lithium and a metal, e.g., cobalt, manganese, nickel, or combinations thereof may be used.

The composite oxide may be a lithium transition metal composite oxide, e.g., lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following chemical formulas may be used. LiₐA_{1-b}X_{b}O_{2-c}D′_{c} (0.90≤a≤1.8, 0≤b≤0.5, and 0≤c≤0.05); LiₐMn_{2-b}X_{b}O_{4-c}D′_{c} (0.90≤a≤1.8, 0≤b≤0.5, and 0c≤0.05); LiₐNi_{1-b-c}Co_{b}X_{c}O_{2-α}D′_{α} (0.90≤a≤1.8, 0≤b≤0.5, 0≤c≤0.5, and 0<α<2); LiₐNi_{1-b-c}Mn_{b}X_{c}O_{2-α}D′_{α} (0.90≤a≤1.8, 0≤b≤0.5, 0≤c≤0.5, and 0<α<2); LiₐNi_{b}Co_{c}L¹_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above chemical formulas, A may be, e.g., Ni, Co, Mn, or a combination thereof, X may be, e.g., Al, Ni, Co, Mn, Cr, Fe, Mg, Sr, V, a rare earth element or a combination thereof, D′ may be, e.g., O, F, S, P, or a combination thereof, G may be, e.g., Al, Cr, Mn, Fe, Mg, La, Ce, Sr, V, or a combination thereof, and L¹ is, e.g., Mn, Al, or a combination thereof.

In an implementation, the positive electrode active material may be, e.g., a high nickel-based positive electrode active material having a nickel amount of, e.g., greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may realize high capacity and may be applied to a high-capacity, high-density rechargeable lithium battery.

In the positive electrode, an amount of the positive electrode active material may be, e.g., about 90 wt % to about 98 wt % based on a total weight of the positive electrode active material layer. Each amount of the binder and the conductive material may be, e.g., 1 wt % to 5 wt % based on a total weight of the positive electrode active material layer.

The binder may serve to well attach the positive electrode active material particles to each other and also to well attach the positive electrode active material to the current collector. Examples of the binder may include, e.g., polyvinyl alcohol, carboxymethyl cellulose, hydroxypropyl cellulose, diacetyl cellulose, polyvinylchloride, carboxylated polyvinylchloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material may be used to impart conductivity to the electrode, and any material that does not cause chemical change and conducts electrons may be used in the battery. Examples of the conductive material may include, e.g., a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof. The current collector may include, e.g., Al.

### [Electrolyte]

The electrolyte may include a non-aqueous organic solvent and a lithium salt. The non-aqueous organic solvent may serve as a medium for transmitting ions taking part in the electrochemical reaction of a battery.

The non-aqueous organic solvent may be, e.g., a carbonate-based, ester-based, ether-based, ketone-based, or alcohol-based solvent, an aprotic solvent, or a combination thereof.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include, e.g., methyl acetate, ethyl acetate, n-propyl acetate, dimethyl acetate, methyl propionate, ethyl propionate, decanolide, mevalonolactone, valerolactone, caprolactone, or the like. The ether-based solvent may include, e.g., dibutyl ether, tetraglyme, diglyme, dimethoxyethane, 2-methyltetrahydrofuran, 2,5-dimethyltetrahydrofuran, tetrahydrofuran, or the like. The ketone-based solvent may include, e.g., cyclohexanone or the like. The alcohol-based solvent may include, e.g., ethanol, isopropyl alcohol, or the like and the aprotic solvent may include, e.g., nitriles such as R—CN (wherein R may be, e.g., a C2 to C20 linear, branched, or cyclic hydrocarbon group, a double bond, an aromatic ring, or an ether bond, or the like); amides, e.g., dimethylformamide; dioxolanes, e.g., 1,3-dioxolane, 1,4-dioxolane, or the like; sulfolanes, or the like.

The non-aqueous organic solvents may be used alone or in combination of two or more. If using a carbonate-based solvent, a cyclic carbonate and a chain carbonate may be mixed and used, and the cyclic carbonate and the chain carbonate may be mixed in a volume ratio of, e.g., about 1:1 to about 1:9.

The lithium salt dissolved in the organic solvent may supply lithium ions in a battery, enable a basic operation of a rechargeable lithium battery, and improve transportation of the lithium ions between positive and negative electrodes. In an implementation, the lithium salt may include, e.g., LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y may be integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

### [Separator]

Depending on the type of the rechargeable lithium battery, a separator may be present between the positive electrode and the negative electrode. The separator may include, e.g., polyethylene, polypropylene, polyvinylidene fluoride, or a multilayer film of two or more layers thereof, and a mixed multilayer film, e.g., a polyethylene/polypropylene two-layer separator, polyethylene/polypropylene/polyethylene three-layer separator, polypropylene/polyethylene/polypropylene three-layer separator, or the like.

The separator may include a porous substrate and a coating layer including an organic material, an inorganic material, or a combination thereof on one or both surfaces of the porous substrate.

The porous substrate may be a polymer film formed of, e.g., polymer polyolefin, e.g., polyethylene and polypropylene, polyester, e.g., polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, or polytetrafluoroethylene, or a copolymer or mixture of two or more thereof.

The organic material may include a polyvinylidene fluoride-based polymer or a (meth)acrylic polymer. The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The organic material and the inorganic material may be mixed in one coating layer, or a coating layer including an organic material and a coating layer including an inorganic material may be stacked.

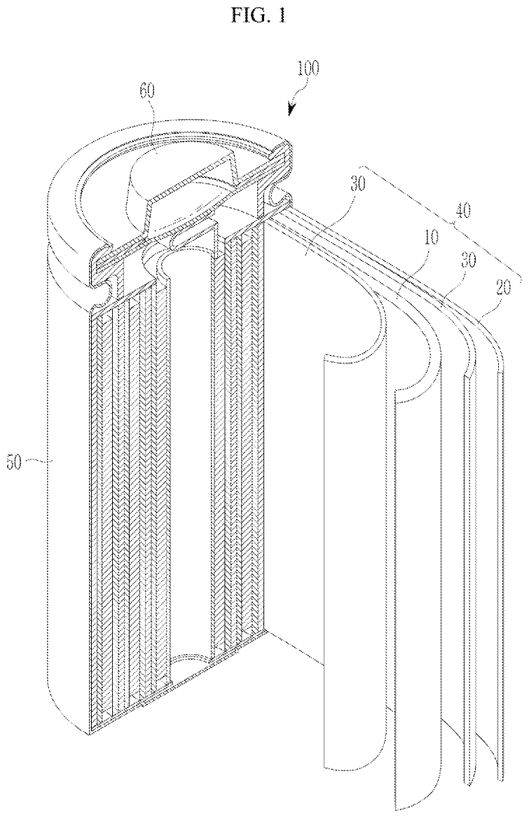

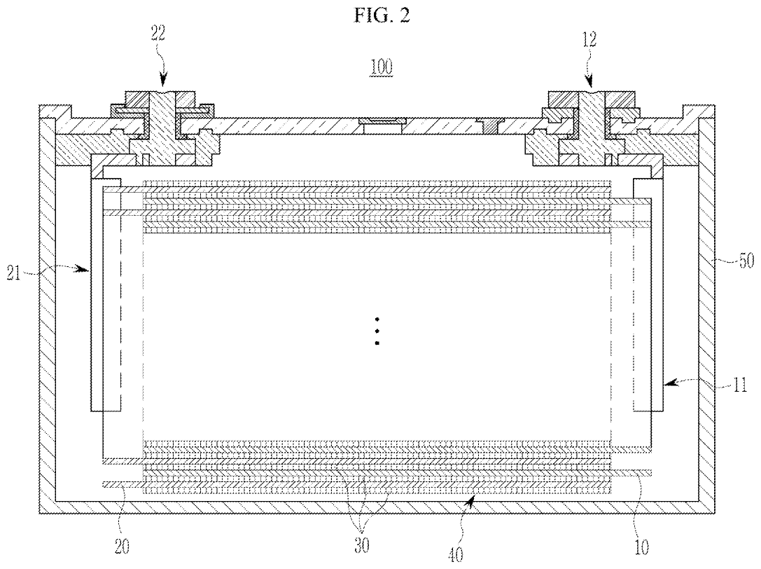

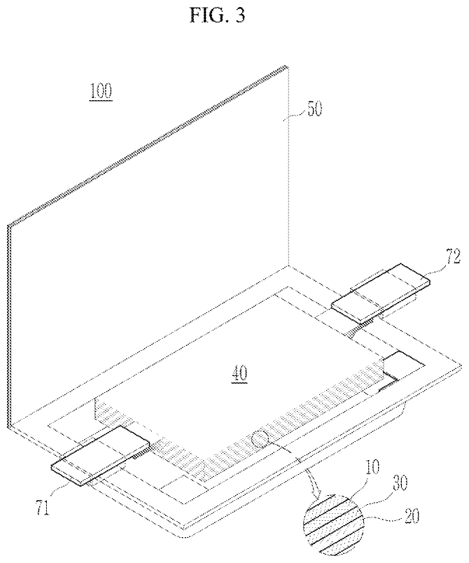

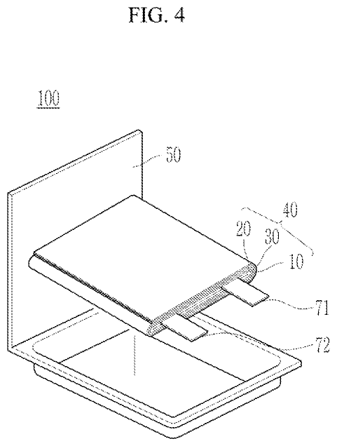

The rechargeable lithium battery may be classified into cylindrical, prismatic, pouch, coin, and the like depending on their shape. FIGS. 1 to 4 are schematic views illustrating a rechargeable lithium battery according to embodiments. FIG. 1 shows a cylindrical battery, FIG. 2 shows a prismatic battery, and FIGS. 3 and 4 show pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 may be housed. The positive electrode 10, the negative electrode 20, and the separator 30 may be impregnated with an electrolyte. The rechargeable lithium battery 100 may include a sealing member 60 sealing the case 50 as shown in FIG. 1. In FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 may include a positive electrode tab 71 and a negative electrode tab 72 serving as an electrical path for inducing the current formed in the electrode assembly 40 to the outside.

The rechargeable lithium battery according to an embodiment may be applied to automobiles, mobile phones, and/or various types of electric devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

Polyacrylonitrile was added to dimethyl formamide and dissolved therein to prepare a polyacrylonitrile liquid.

To the polyacrylonitrile liquid, a silicon-carbon composite was added and then, stirred to prepare a mixture. Herein, the polyacrylonitrile and the silicon-carbon composite were mixed in a weight ratio of 2:98.

The silicon-carbon composite included an agglomerated product which was a secondary particle where silicon nanoparticles with an average particle diameter of 100 nm were agglomerated, and a soft carbon coating layer formed on the surface of the agglomerated product, wherein an amount of the silicon nanoparticle was 60 wt %, and an amount of the soft carbon amorphous carbon was 40 wt % based on 100 wt % of the total silicon-carbon composite. The soft carbon coating layer had a thickness of 100 nm.

The mixture was dried at 80° C. to remove the dimethyl formamide.

The obtained dried product was heat-treated at 200° C. for 60 minutes to prepare a negative electrode active material including a silicon-carbon composite core and a polymer coating layer formed on the silicon-carbon composite core surface.

The polymer coating layer had linear polyacrylonitrile and cyclic polyacrylonitrile in a weight ratio of 80:20. In the negative electrode active material, an amount of the polymer coating layer was 2 wt % based on 100 wt % of the total negative electrode active material.

97.5 wt % of the prepared negative electrode active material, 1.5 wt % of carboxymethyl cellulose, and 1 wt % of a styrene butadiene rubber were mixed in a water solvent to prepare negative electrode active material layer slurry.

The negative electrode active material layer slurry was coated on a Cu foil current collector and then, dried and pressed to form a negative electrode active material layer and thus a negative electrode.

The negative electrode was used with a LiNi_{0.8}Co_{0.1}Mn_{0.1}O₂ positive electrode and an electrolyte to manufacture a full cell. The electrolyte was a 1 M LiPF₆ solution in a mixed solvent of ethylene carbonate and dimethyl carbonate (in a volume ratio of 3:7).

### Example 2

A negative electrode active material was prepared in the same manner as in Example 1 except that the dried product was heat-treated at 230° C. for 60 minutes.

The negative electrode active material was used in the same manner as in Example 1 to manufacture a negative electrode and a full cell.

### Example 3

A negative electrode active material was prepared in the same manner as in Example 1 except that the dried product was heat-treated at 250° C. for 60 minutes.

The negative electrode active material was used in the same manner as in Example 1 to manufacture a negative electrode and a full cell.

### Example 4

A negative electrode active material was prepared in the same manner as in Example 1 except that the dried product was heat-treated at 270° C. for 60 minutes.

The negative electrode active material was used in the same manner as in Example 1 to manufacture a negative electrode and a full cell.

### Example 5

A negative electrode active material was prepared in the same manner as in Example 1 except that the dried product was heat-treated at 300° C. for 60 minutes.

The negative electrode active material was used in the same manner as in Example 1 to manufacture a negative electrode and a full cell.

### Example 6

A negative electrode active material was prepared in the same manner as in Example 1 except that the mixing ratio of the polyacrylonitrile and the silicon-carbon composite was changed into 1:99.

The negative electrode active material was used in the same manner as Example 1 to manufacture a negative electrode and a full cell.

### Example 7

A negative electrode active material was prepared in the same manner as in Example 1 except that the mixing ratio of the polyacrylonitrile and the silicon-carbon composite was changed into 3:97.

The negative electrode active material was used in the same manner as Example 1 to manufacture a negative electrode and a full cell.

### Example 8

A negative electrode active material was prepared in the same manner as in Example 1 except that the mixing ratio of the polyacrylonitrile and the silicon-carbon composite was changed into 5:95.

The negative electrode active material was used in the same manner as Example 1 to manufacture a negative electrode and a full cell.

### Comparative Example 1

A negative electrode and a full cell were manufactured in the same manner as in Example 1 except that the silicon-carbon composite used in Example 1 was used as a negative electrode active material.

### Comparative Example 2

A negative electrode active material was manufactured in the same manner as in Example 1 except that the dried product was not heat-treated.

The negative electrode active material was used in the same manner as in Example 1 to manufacture a negative electrode and a full cell.

### Comparative Example 3

A negative electrode active material was prepared in the same manner as in Example 1 except that the dried product was heat-treated at 500° C. for 60 minutes. The negative electrode active material was prepared to include a silicon-carbon composite core and a cyclic polyacrylonitrile polymer coating layer formed on the silicon-carbon composite core surface.

The negative electrode active material was used in the same manner as in Example 1 to manufacture a negative electrode and a full cell.

### Experimental Example 1: XRD Measurement

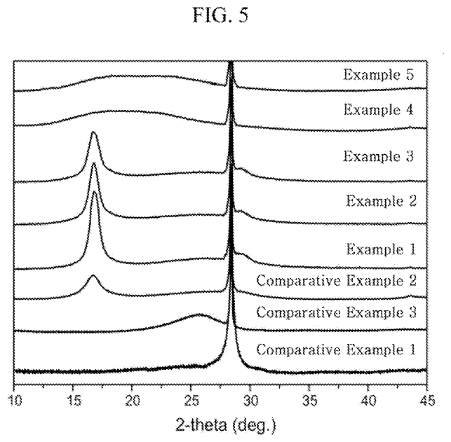

An X-ray diffraction analysis was performed on the negative electrode active materials according to Examples 1 to 8 and Comparative Examples 1 to 3. Among the results, the results of Examples 1 to 5 and Comparative Examples 1 to 3 are shown in FIG. 5. The X-ray diffraction analysis was performed by using CuKα-rays within a range of 2θ=10° to 80°, at a scan speed (°/S) of 0.054, a step size (°/step) of 0.01313, and time/step (time per step) of 62.475 s.

As shown in FIG. 5, the negative electrode active materials of Examples 1 to 5 exhibited a (100) plane peak and a (002) plane peak as the XRD results. On the contrary, Comparative Example 1 exhibited neither (100) plane peak nor (002) plane peak, and Comparative Example 2 exhibited a (100) plane peak alone. Comparative Example 3 exhibited a (002) plane peak alone.

Furthermore, an intensity ratio (I(002)/I(100)) of the peaks was calculated, and the results are shown in Table 1.

### Experimental Example 2: FT-IR Measurement

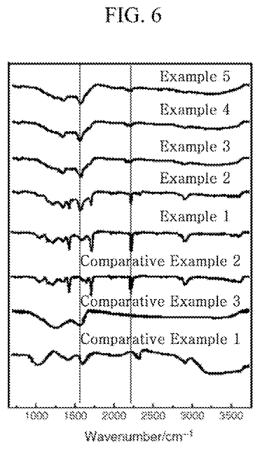

FT-IR on the negative electrode active materials of Examples 1 to 8 and Comparative Examples 1 to 3 was measured. Among the results, the results of Examples 1 to 5 and Comparative Examples 1 to 3 are shown in FIG. 6.

As shown in FIG. 6, the negative electrode active materials of Examples 1 to 5 exhibited a first peak derived from —C═N— or —C═C—, appearing at a wavelength of 1550 cm⁻¹ to 1650 cm⁻¹ and a second peak derived from —C≡N, appearing at a wavelength of 2200 cm⁻¹ to 2300 cm⁻¹. Comparative Example 1 exhibited neither first nor second peak, Comparative Example 2 exhibited a second peak alone, and Comparative Example 3 exhibited a first peak alone.

A ratio of the second peak to the first peak was calculated. The results are shown in Table 1.

### Experimental Example 3: Evaluation of Cycle-Life Characteristics

The cells of Examples 1 to 8 and Comparative Examples 1 to 3 were charged and discharged, within a range of 2.5 V to 4.2 V, once at 0.1 C, once at 0.2 C, and then at 1 C. The charging/discharging method and their cut-off conditions are as follows.
Charge: constant current-constant voltage, 4.2 V/0.01 C cut-off
Discharge: constant voltage, 2.5 V cut-off

A ratio of discharge capacity at each cycle to 1^{st} discharge capacity at 1 C was calculated to check the number of cycles if the capacity ratio sharply decreased to less than 80%. The results are shown in Table 1.

Table 1 shows a total amount of polyacrylonitriles (PAN) in each negative electrode active material, a weight ratio of linear polyacrylonitrile and cyclic polyacrylonitrile, a heat treatment temperature, I(002)/I(100), and a second peak height/first peak height.

TABLE 1

| | | Linear | Cyclic | | | | |
|---|---|---|---|---|---|---|---|
| | PAN | PAN | PAN | Heat treatment | | Second peak | Cycle number at which |
| | amount | amount | amount | temperature | I(002)/ | height/first | cycle-life sharply |
| | (wt %) | (wt %) | (wt %) | (° C.) | I(100) | peak height | decreases (recover) |
| Comparative | — | — | — | X | 0 | 0 | 300 |
| Example 1 | | | | | | | |
| Comparative | 2 | 2 | 0 | X | 0.15 | 0.1 | 300 |
| Example 2 | | | | | | | |
| Example 1 | 2 | 1.6 | 0.4 | 200 | 0.2 | 0.8 | 314 |
| Example 2 | 2 | 1.45 | 0.55 | 230 | 0.3 | 4 | 350 |
| Example 3 | 2 | 0.95 | 1.05 | 250 | 0.8 | 9 | 405 |
| Example 4 | 2 | 0.8 | 1.2 | 270 | 2 | 20 | 380 |
| Example 5 | 2 | 0.4 | 1.6 | 300 | 3 | 30 | 310 |
| Example 6 | 1 | 0.95 | 1.05 | 250 | 0.8 | 9 | 320 |
| Example 7 | 3 | 0.95 | 1.05 | 250 | 0.8 | 9 | 352 |
| Example 8 | 5 | 0.95 | 1.05 | 250 | 0.8 | 9 | 318 |
| Comparative | 2 | 0 | 2 | 500 | 30 | 40 | 300 |
| Example 3 | | | | | | | |

As shown in Table 1, the cells of Examples 1 to 8 using a negative electrode active material having a coating layer including both linear polyacrylonitrile and cyclic polyacrylonitrile exhibited the excellent 310 cycles or more if cycle-life sharply decreased.

On the contrary, the cell of Comparative Example 2 including a polymer coating layer including linear polyacrylonitrile alone and the cell of Comparative Example 3 including a negative electrode active material including a polymer coating layer including cyclic polyacrylonitrile alone exhibited the same results as the cell of Comparative Example 1 including a negative electrode active material including no polymer coating layer.

By way of summation and review, rechargeable lithium batteries may include a positive electrode and a negative electrode including an active material capable of intercalating and deintercalating lithium ions, and an electrolyte solution, and electrical energy may be produced by oxidation and reduction reactions if lithium ions are intercalated/deintercalated at the positive and negative electrodes.

Some embodiments may provide a negative electrode active material that exhibits excellent cycle-life characteristics by suppressing side reactions with an electrolyte.

Some embodiments may provide a rechargeable lithium battery including a negative electrode including the negative electrode active material; a positive electrode; and an electrolyte.

The negative electrode active material according to some embodiments may exhibit excellent cycle-life characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
a core including a silicon-carbon composite; and
a polymer coating layer on the core,
wherein the negative electrode active material has a (100) plane peak and a (002) plane peak during X-ray diffraction measurement using a CuKα ray.

2. The negative electrode active material as claimed as claimed in claim 1, having a first peak appearing at a wavelength of about 1,550 cm⁻¹ to about 1,650 cm⁻¹ and a second peak appearing at a wavelength of about 2,200 cm⁻¹ to about 2,300 cm⁻¹ in an FT-IR analysis graph.

3. The negative electrode active material as claimed as claimed in claim 1, wherein the (100) plane peak appears within a range of 2θ=15° to 20° and the (002) plane peak appears within a range of 2θ=22° to 28°.

4. The negative electrode active material as claimed in claim 1, wherein an intensity ratio of the (002) plane peak to (100) plane peak is in a range of about 0.2 to about 3.

5. The negative electrode active material as claimed in claim 2, wherein a ratio of a height of the second peak to a height of the first peak is about 0.2 to about 30.

6. The negative electrode active material as claimed in claim 1, wherein the polymer coating layer includes linear polyacrylonitrile and cyclic polyacrylonitrile.

7. The negative electrode active material as claimed in claim 6, wherein a mixing ratio of the linear polyacrylonitrile and the cyclic polyacrylonitrile is about 20:80 to about 80:20 by weight.

8. The negative electrode active material as claimed in claim 7, wherein the mixing ratio of the linear polyacrylonitrile and the cyclic polyacrylonitrile is about 40:60 to about 60:40 by weight.

9. The negative electrode active material as claimed in claim 1, wherein an amount of the polymer coating layer is about 0.1 wt % to about 5 wt % based on a total weight of the negative electrode active material.

10. The negative electrode active material as claimed in claim 9, wherein an amount of the polymer coating layer is about 0.5 wt % to about 3 wt % based on a total weight of the negative electrode active material.

11. The negative electrode active material as claimed in claim 1, wherein a thickness of the polymer coating layer is about 1 nm to about 30 nm.

12. The negative electrode active material as claimed in claim 1, wherein the silicon-carbon composite includes silicon nanoparticles and an amorphous carbon coating layer on a surface of the silicon nanoparticles.

13. The negative electrode active material as claimed in claim 12, wherein the silicon nanoparticles have a diameter of about 10 nm to about 1,000 nm.

14. The negative electrode active material as claimed in claim 12, wherein the silicon-carbon composite further includes crystalline carbon.

15. A method of preparing a negative electrode active material, comprising:
preparing a mixture by mixing polyacrylonitrile liquid and silicon-carbon composite;
drying the mixture to produce a dried product; and
performing a heat treatment on the dried product.

16. The method of preparing a negative electrode active material as claimed in claim 15, wherein the polyacrylonitrile liquid includes linear polyacrylonitrile and an organic solvent.

17. The method of preparing a negative electrode active material as claimed in claim 15, wherein a mixing ratio of polyacrylonitrile and the silicon-carbon composite is about 0.01:99.9 to about 5:95 by weight.

18. The method of preparing a negative electrode active material as claimed in claim 15, wherein the drying is performed at about 60° C. to about 120° C.

19. The method of preparing a negative electrode active material as claimed in claim 15, wherein the heat treatment performed at about 200° C. to about 400° C.

20. A rechargeable lithium battery, comprising:
a negative electrode including the negative electrode active material of claim 1;
a positive electrode; and
an electrolyte.
